(19) United States
(12) Patent Application Publication
(10) Pub. No.: US 2007/0229029 A1
(43) Pub. Date: Oct. 4, 2007

(54) Battery power detecting system and method

(75) Inventor: Kun-Hung Huang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,955

(22) Filed: Mar. 30, 2006

(51) Int. Cl. H02J 7/00

(52) U.S. Cl. 320/115

(57) ABSTRACT

A battery power detecting system is disclosed applicable to an electronic device having a volatile random access memory (VRAM) for detecting the battery power of a backup battery of the volatile random access memory. The battery power detecting system includes a detection module for detecting the battery power of the backup battery and for generating a detection signal; a reception module for receiving the detection signal; and a determination module for reading a state value of the detection signal received by the reception module, determining the battery power of the backup battery according to the state value, and generating alarm messages to notify a user that the backup battery is lacking in battery power when the backup battery is determined to be have insufficient battery power, so as to prevent data stored in the VRAM from being lost due to the lack of the battery power of the backup battery.

### BACKGROUND OF THE INVENTION

1. Field of the Invention

The present invention relates to battery power detecting techniques; and, more particularly, to a battery power detecting system and method applicable to an electronic device having a volatile random access memory (VRAM) for detecting the backup battery power of the VRAM.

2. Description of Related Arts

In general, an electronic computing device comprises a volatile random access memory (VRAM), which is used for storing a user's specified settings, such as the setup data of the basic input/output (BIOS) system of the device. However, because the VRAM will lose data if supplied electrical power runs low, the electronic device is provided with a backup battery specified for the VRAM. Therefore, even if the electronic device is powered-off, the VRAM can still maintain the data.

Moreover, the VRAM has to have a working voltage approximately within 2.5-2.8V to reliably hold data. However, since the electronic device of the prior art is not provided with a battery power detecting mechanism, when the battery power provided by the backup battery of the VRAM is insufficient for the VRAM to hold data, and a user of the electronic device does not replace the backup battery with a new battery with sufficient power in time, the data stored in the VRAM will be lost due to the lack of battery power of the backup battery when the electronic device is powered-off.

Therefore, most manufacturers install a battery power detecting mechanism in the electronic device to detect the battery power of the backup battery. However, such a battery power detecting mechanism of the prior art does not generate any alarm messages to notify the user to replace the backup battery with a new battery with sufficient battery power until the battery power of the backup battery is lower than a very small threshold power. Consequently, the VRAM still loses its data.

Therefore, it is desirable in the art to propose an effective battery power detecting mechanism that can warn a user to replace the backup battery in time to prevent the VRAM from losing data due to a lack of battery power of the backup battery.

### SUMMARY OF THE INVENTION

In view of the above-mentioned problems of the prior art, it is a primary objective of the present invention to provide a battery power detecting system and method, both of which are applicable to an electronic device having a volatile random access memory (VRAM) for detecting the battery power of a backup battery of the VRAM, and generating alarm messages to notify a user of the electronic device to replace the backup battery with a new battery with sufficient battery power when the backup battery is determined to be lacking in battery power, so as to prevent data stored in the VRAM from being lost due to the lack of the battery power of the backup battery after the electronic device is powered-off.

It is another objective of the present invention to provide a more effective battery power detecting system and method.

To achieve the above-mentioned and other objectives, a battery power detecting system is provided according to the present invention. The battery power detecting system is applicable in an electronic device having a volatile random access memory for detecting the battery power of a backup battery of the volatile random access memory. The battery power detecting system includes a detection module for detecting the battery power of the backup battery and generating a detection signal; a reception module for receiving the detection signal; and a determination module for reading a state value of the detection signal received by the reception module, determining the battery power of the backup battery according to the state value, and generating alarm messages to notify a user of the electronic device that the backup battery is lacking sufficient battery power when the backup battery is determined to have insufficient power.

According to the preferred embodiment, the reception module is an input/output chipset having a general-purpose input/output (GPIO) pin for receiving the detection signal.

Moreover, the determination module is a basic input/output system (BIOS) for reading the state value of the detection signal from a power-on self test (POST) process, determining the battery power of the backup battery according to the state value, and generating alarm messages and outputting the alarm messages to a display unit of the electronic device when the backup battery is determined to be lacking in battery power when the electronic device is powered-on and is reading the BIOS and executing the POST process.

In another embodiment, the determination module is a driver program for reading the state value of the detection signal, determining the battery power of the backup battery according to the state value, and generating alarm messages and outputting the alarm message to a display unit of the electronic device when the backup battery is determined to be lacking in battery power when the electronic device is powered-on and is executing an operating system (OS).

The battery power detecting method is applicable in an electronic device having a volatile random access memory for detecting the battery power of a backup battery of the volatile random access memory. The battery power detecting method includes detecting the battery power of the backup battery and generating a detection signal;

receiving the detection signal; and reading a state value of the detection signal received by the reception module, determining the battery power of the backup battery according to the state value, and generating alarm messages to notify a user of the electronic device that the backup battery is lacking in battery power when the backup battery is determined to be lacking in battery power.

The battery power detecting method further includes outputting the alarm messages to a display unit of the electronic device, allowing the display unit to display the alarm messages.

Detecting the battery power of the backup battery and generating a detection signal of the battery power detecting method is implemented by a detection module.

Receiving the detection signal is implemented by a reception module of the battery power detecting method, such as an input/output chipset having a GPIO pin for receiving the detection signal and determining the battery power of the backup battery.

Reading a state value of the detection signal received by the reception module, determining the battery power of the backup battery according to the state value, and generating alarm messages to notify a user of the electronic device that the backup battery is lacking in battery power when the backup battery is determined to be lacking in battery power is implemented by a determination module of the battery power detecting method.

Compared with the prior art, the battery power detecting system and method of the present invention have the detection module detect the battery power of the backup battery and generate the detection signal, have the reception module receive the detection signal and store the state value of the detection signal, have the determination module determine the battery power of the backup battery according to the state value of the detection signal and generate alarm messages if the backup battery is determined to be lacking in battery power, and have the display unit display the alarm messages. Therefore, the user can take notice of the alarm messages displayed on the display unit to know that the backup battery is lacking in battery power, and replace the backup battery with a new battery with sufficient battery power in time, so as to prevent the data stored in the VRAM from disappearing due to the lack of battery power of the backup battery.

### BRIEF DESCRIPTIONS OF THE DRAWINGS

FIG. 1 is a functional block diagram of an electronic device having a battery power detecting system of the preferred embodiment according to the present invention;

FIG. 2 is a circuit diagram of a detection module and a reception module of the battery power detecting system shown in FIG. 1; and

FIG. 3 is a flow chart of a battery power detecting method corresponding to the battery power detecting system shown in FIG. 1.

### DETAILED DESCRIPTIONS OF PREFERRED EMBODIMENTS

The following illustrative embodiments are provided to illustrate the disclosure of the present invention, these and other advantages and effects being readily understandable by those in the art after reading the disclosure of this specification. The present invention can also be performed or applied by other differing embodiments. The details of the specification may be changed on the basis of different points of view and applications, and numerous modifications and variations can be devised without departing from the spirit of the present invention.

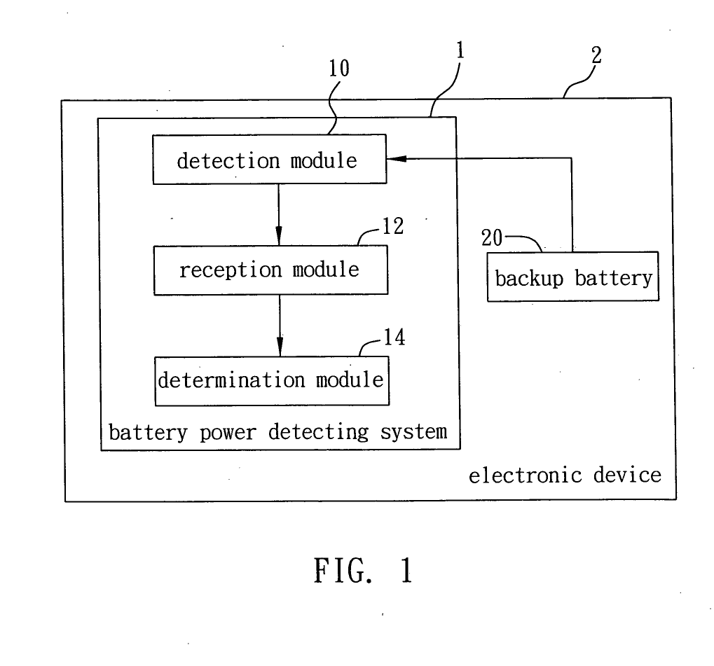

FIG. 1 is a functional block diagram of an electronic device 2 having a battery power detecting system 1 of the preferred embodiment according to the present invention. The battery power detecting system 1 is applicable in the electronic device 2 having a volatile random access memory (VRAM) and is used for detecting (or monitoring) battery power of a backup battery 20 of the VRAM. The VRAM, for example a CMOS memory, is used for storing data set by users, such as setup data of a basic input/output system (BIOS) of the electronic device 2. According to the preferred embodiment, the electronic device 2 is a personal computer (PC) such as a desktop computer or a notebook computer, or a personal digital assistant (PDA).

The battery power detecting system 1 of the present invention comprises a detection module 10, a reception module 12 and a determination module 14, all of which will be described in detail in the following description.

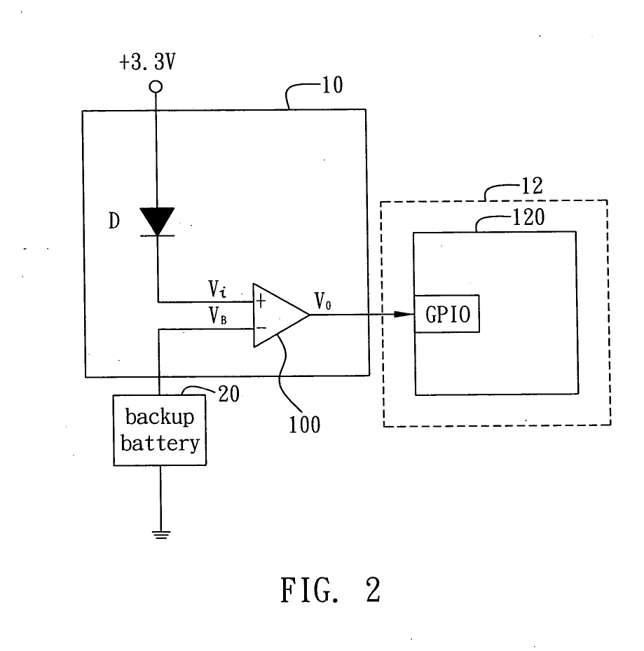

The detection module 10 is used to detect the battery power of the backup battery 20, and generate a detection signal, which will be transferred to the reception module 12 for subsequent processes. Referring to FIG. 2, which is a circuit diagram of the detection module 10 and the reception module 12, according to the preferred embodiment, the detection module 10 is composed of a voltage level comparator 100 and a plurality of peripheral devices and circuit layouts. The voltage level comparator 100 has a positive input (+) connected to a stand-by power source circuit (3.3V) of the electronic device 2. Note that the stand-by power source circuit (3.3V) is an independent power source circuit and is capable of generating a power having a voltage level of 3.3 volts, for example, when receiving electrical energy. However, because the VRAM has a working voltage approximately within 2.5-2.8V, a diode D is connected between the positive input (+) of the voltage level comparator 100 and the stand-by power source circuit (3.3V) to drop 0.7V, so as to input an input voltage signal Vᵢ of 2.6V to the positive input (+) of the voltage level comparator 100. Of course, the voltage drop of the diode D of the present invention is not fixed, and can be changed according to practical demands. The voltage level comparator 100 further has a negative input (−) connected to the backup battery 20, and the voltage level of the backup battery 20 serves as a battery voltage signal V_{B} input to the negative input (−). The voltage level comparator 100 further has an output having an output signal Vo, that is the above-mentioned detection signal. According to the preferred embodiment, the battery power of the backup battery 20 can be known through detection of the output signal Vo.

As described above, the working voltage of the VRAM is within 2.5-2.8V, and, in order to ensure that the VRAM still hold data after the electronic device 2 is powered-off, the backup battery 20 has to provide to the VRAM a voltage level of at least 2.4V, a minimum voltage level for the VRAM to hold data. According to the preferred embodiment, the input voltage level of 2.6V is used as a reference voltage.

When the battery voltage level V_{B} of the backup battery 20 is lower than the input voltage level Vᵢ, the output signal Vo is a high-level signal (logic signal “1”), or the output signal Vo is a low-level signal (logic signal “0”), depending on the design requirements.

The reception module 12 is used to receive the detection signal (that is the output signal Vo) output by the detection module 10, and stores a state value (logic signal “1” or “0”) of the detection signal. As shown in FIG. 2, the reception module 12 is an input/output chipset 120, such as a north bridge chipset or a south bridge chipset. The input/output chipset 120 comprises a general purpose input/output (GPIO) pin. According to the preferred embodiment, a user has to have the BIOS of the electronic device 2 format the GPIO pin in advance so that the GPIO pin is capable of receiving the detection signal (that is the output signal Vo) output by the detection module 10.

According to the preferred embodiment, the voltage level comparator 100 outputs the output signal Vo to the GPIO pin of the input/output chipset 120 so that the GPIO pin is allowed to receive the output signal Vo and store the state value (that is the logic signal “1” or “0”) of the output signal Vo.

The determination module 14 is used to read the state value of the detection signal stored in the reception module 12, determine the battery power of the backup battery 20 according to the state value (the logic signal “1” and “0”), and generate alarm messages to notify the user when the backup battery 20 is detected to be lacking in battery power.

In practice, when reading a state value of the detection signal being equal to the logic signal “1”, the determination module 14 determines that the backup battery 20 is lacking in battery power, and thereby generates alarm messages to notify the user; on the contrary, when reading a state value of the detection signal being equal to the logic signal “0”, the determination module 14 determines that the backup battery 20 still has abundant battery power, and does not generate any alarm messages.

The battery power detecting system 1 works only when the electronic device 2 is powered-on and is executing the POST process since the battery power detecting system 1 reads the detection signal (that is the output signal Vo) from the POST process, then determines the battery power of the backup battery 20 according to the state value and generates alarm messages to notify the user when the backup battery 20 is determined to be lacking in battery power, and finally displays alarm messages on a display unit (not shown). Therefore, the user can take notice of the alarm messages displayed on the display unit and know that the backup battery 20 is lacking in battery power, and replace the backup battery 20 with a new battery with sufficient battery power in time, so as to prevent the data stored in the VRAM from being lost due to the lack of battery power of the backup battery 20.

According to another embodiment of the present invention, the battery power detecting system 1 can still work when the electronic device 2 is powered-on and is executing an operating system (OS). Accordingly, the determination module 14 is a driver program since it reads the state value of the detection signal, determines the battery power of the backup battery 20 according to the state value, and generates alarm messages to notify the user when the backup battery 20 is determined to be lacking in battery power. The driver program can further output the alarm messages to the display unit of the electronic device 2. Therefore, the user can know that the backup battery 20 is lacking in battery power through interpretation of the alarm messages displayed on the display unit, and replace the backup battery 20 with a new battery with sufficient battery power in time, so as to prevent the data stored in the VRAM from being lost due to lack of battery power of the backup battery 20.

In summary, the battery power detecting system of the present invention, after the electronic device 2 reads the BIOS and executes the POST process or executes the OS and the driver program, has the input/output chipset acquire the state value (that is the detection signal, which is output from the output Vo of the voltage level comparator 100) received by the GPIO pin, determine the battery power of the backup battery 20 according to the state value, generate alarm messages to notify the user when the backup battery 20 is determined to be lacking in battery power, and finally display the alarm messages on the display unit. Therefore, the user can take notice of the alarm messages displayed on the display unit to know when the backup battery 20 is lacking in battery power, and replace the backup battery 20 with a new battery with sufficient battery power in time, so as to prevent the data stored in the VRAM from being lost due to the lack of battery power of the backup battery 20.

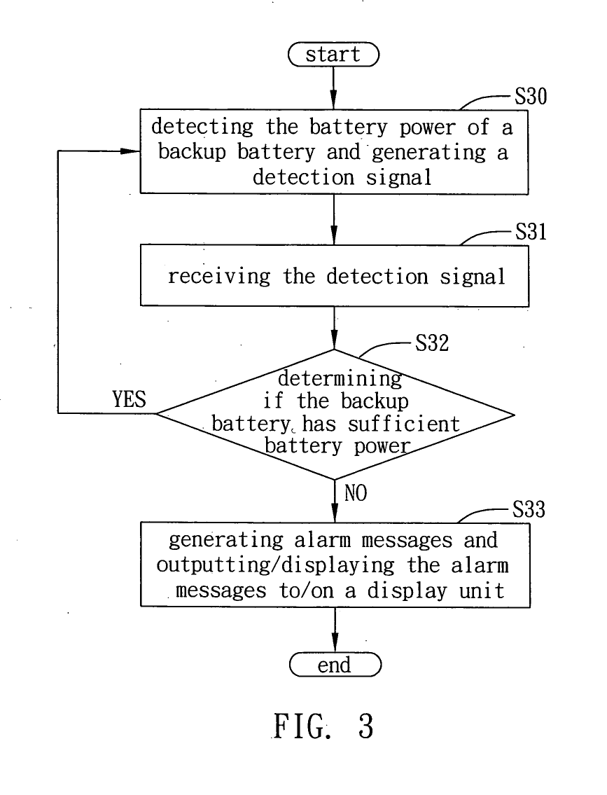

FIG. 3 is a flow chart of a battery power detecting method corresponding to the battery power detecting system 1 of the present invention. The battery power detecting method starts in step S30. In step S30, the detection module 10 detects the battery power of the backup battery 20, and generates detection signal (that is the output signal Vo). Then, flow proceeds to step S31.

In step S31, the reception module 12 receives the detection signal (the state value of the output signal Vo is either the logic signal “0” or the logic signal “1”) output by the detection module 10. Then, flow proceeds to step S32.

In step S32, the determination module 14 reads the state value of the detection signal received by the reception module 12, and determines if the backup battery 20 has sufficient battery power according to the state value. In practice, in step S32, when reading a state value of the detection signal equal to the logic value “1”, the determination module 14 determines that the backup battery 20 is lacking in battery power, and the battery power detecting method proceeds to step S33. On the other hand, when reading a state value of the detection signal being equal to the logic value “0”, the determination module 14 determines that the backup battery 20 still has sufficient battery power according to the logic value “0”, and does not generate any alarm messages, and, then, the battery power detecting method returns to step S30.

In step S33, the determination module 14 generates alarm messages, and outputs the alarm messages to the display unit of the electronic device 2. Therefore, the user can take notice of the alarm messages displayed on the display unit to know that the backup battery 20 is lacking in battery power, and replace the backup battery 20 with a new battery with sufficient battery power in time, so as to prevent the data stored in the VRAM from being lost due to the lack of battery power of the backup battery 20.

According to the above description, the battery power detecting method works when the electronic device 2 is powered-on. In step S32 the determination module 14 is the BIOS, and is capable of reading the state value of the detection signal (that is the output signal Vo) from the POST process when the electronic device 2 is reading the BIOS and executing the POST process, determining the battery power of the backup battery 20, and generating alarm messages and outputting the alarm messages to the display unit of the electronic device 2. Therefore, the user can know that the backup battery 20 is lacking in battery power through interpretation of the alarm messages displayed on the display unit, and replace backup battery 20 with a new battery with sufficient battery power in time, so as to prevent the data stored in the VRAM from being lost due to the lack of battery power of the backup battery 20.

According to another embodiment of the present invention, the battery power detecting method works when the electronic device is powered-on and is executing the OS. In step S32 the determination module 14 is a driver program that is capable of reading the state value of the detection signal, determining the battery power of the backup battery 20 according to the state value, generating alarm messages when the backup battery 20 is determined to be lacking in battery power, and outputting the alarm messages to the display unit of the electronic device 2. Therefore, the user can take notice of the alarm messages displayed on the display unit and know that the backup battery 20 is lacking in battery power, and replace the backup battery 20 with a new battery with sufficient battery power in time, so as to prevent the data stored in the VRAM from being lost due to the lack of battery power of the backup battery 20.

Therefore, the battery power detecting system and method of the present invention have the detection module 10 detect the battery power of the backup battery 20 and generate the detection signal, have the reception module 12 receive the detection signal and stored the state value (for example the logic signal “1” or the logic signal “0”) of the detection signal, have the determination module 14 determine the battery power of the backup battery 20 according to the state value of the detection signal and generate he alarm messages if the backup battery 20 is determined to be lacking in battery power, and have the display unit display the alarm messages. Therefore, the user can take notice of the alarm messages displayed on the display unit to know that the backup battery 20 is lacking in battery power, and replace the backup battery 20 with a new battery with sufficient battery power in time, so as to prevent the data stored in the VRAM from being lost due to the lack of battery power of the backup battery 20.

Moreover, the user is notified to replace the backup battery 20 with a new battery with sufficient battery power by the alarm messages output by the battery power detecting system and method of the present invention. Compared with the prior art, the present invention helps prevent the data stored in the VRAM from being lost due to a lack of battery power of the backup battery 20 by warning a user to replace the backup battery.

The foregoing descriptions of the detailed embodiments are illustrated to disclose the features and functions of the present invention and are not restrictive of the scope of the present invention. It should be understood by those in the art that various modifications and variations can be made to the present invention according to the spirit and principles of the disclosure and still fall within the scope of the invention as described in the appended claims.

What is claimed is:

1. A battery power detecting system applicable to an electronic device having a volatile random access memory for detecting the battery power of a backup battery of the volatile random access memory, the battery power detecting system comprising:
a detection module for detecting the battery power of the backup battery and generating a detection signal;
a reception module for receiving the detection signal; and
a determination module for reading a state value of the detection signal received by the reception module, determining the battery power of the backup battery according to the state value, and generating alarm messages to notify a user of the electronic device that the backup battery is lacking in battery power when the backup battery is determined to be lacking in battery power.

2. The battery power detecting system of claim 1, wherein the reception module is an input/output chipset having a general-purpose input/output (GPIO) pin for receiving the detection signal.

3. The battery power detecting system of claim 1, wherein the determination module is a basic input/output system (BIOS) for reading the state value of the detection signal from a power-on self test (POST) process, determining the battery power of the backup battery according to the state value, and generating alarm messages and outputting the alarm message to a display unit of the electronic device when the backup battery is determined to be lacking in battery power when the electronic device is powered-on and is reading the BIOS and executing the POST process.

4. The battery power detecting system of claim 1, wherein the determination module is a driver program for reading the state value of the detection signal, determining the battery power of the backup battery according to the state value, and generating alarm messages and outputting the alarm message to a display unit of the electronic device when the backup battery is determined to be lacking in battery power when the electronic device is powered-on and is executing an operating system (OS).

5. A battery power detecting method applicable in an electronic device having a volatile random access memory for detecting the battery power of a backup battery of the volatile random access memory, the battery power detecting method comprising:
detecting the battery power of the backup battery and generating a detection signal;
receiving the detection signal; and
reading a state value of the detection signal received by the reception module, determining the battery power of the backup battery according to the state value, and generating alarm messages to notify a user of the electronic device that the backup battery is lacking in battery power when the backup battery is determined to be lacking in battery power.

6. The battery power detecting method of claim 5, further comprising outputting the alarm messages to a display unit of the electronic device, allowing the display unit to display the alarm messages.

7. The battery power detecting method of claim 5, wherein detecting the battery power of the backup battery and generating a detection signal is implemented by a detection module.

8. The battery power detecting method of claim 5, wherein receiving the detection signal is implemented by a reception module.

9. The battery power detecting method of claim 8, wherein the detection module is an input/output chipset having a GPIO pin for receiving the detection signal and determining the battery power of the backup battery.

10. The battery power detecting method of claim 5, wherein reading a state value of the detection signal received by the reception module, determining the battery power of the backup battery according to the state value, and generating alarm messages to notify a user of the electronic device that the backup battery is lacking in battery power when the backup battery is determined to be lacking in battery power is implemented by a determination module.

11. The battery power detecting method of claim 10, wherein the determination module is a BIOS for reading the state value of the detection signal from a POST process, determining the battery power of the backup battery according to the state value, and generating alarm messages and outputting the alarm message to a display unit of the electronic device when the backup battery is determined to be lacking in battery power when the electronic is powered-on and is reading the BIOS and executing the POST process.

12. The battery power detecting method of claim 10, wherein the determination module is a driver program for reading the state value of the detection signal, determining the battery power of the backup battery according to the state value, and generating alarm messages and outputting the alarm message to a display unit of the electronic device when the backup battery is determined to be lacking in battery power when the electronic device is powered-on and is executing an operating system (OS).
